(19) United States
(12) Patent Application Publication
(10) Pub. No.: US 2022/0176526 A1
(43) Pub. Date: Jun. 9, 2022

(54) TORQUE SCREWDRIVER ARRANGEMENT AND METHOD FOR OPERATING SUCH A TORQUE SCREWDRIVER ARRANGEMENT

(71) Applicant: SWEDEX GmbH Industrieprodukte, Neuss (DE)

(72) Inventors: Andreas USHAKOV, Dormagen (DE); Andreas LAZAR, Neuss (DE); Marc UTZENRATH, Grevenbroich (DE)

(21) Appl. No.: 17/436,767

(22) PCT Filed: Feb. 28, 2020
(86) PCT No.: PCT/EP2020/055348

§ 371 Date: Sep. 7, 2021

(30) Foreign Application Priority Data
Mar. 8, 2019 (DE) 20 2019 101 333.8

(51) Int. Cl. B25B 23/147; B25B 21/00

(52) U.S. Cl. CPC B25B 23/147; B25B 21/00

(57) ABSTRACT

A screwdriver arrangement has: a screwdriver housing; a drivetrain, arranged in the screwdriver housing and which comprises a drive housing, a motor in the drive housing, in particular an electric motor, and an output shaft protruding from the drive housing at the axial front face. The axial front end of the output shaft comprises a bit holder for fixing a screw bit or is connectable to such a bit holder for conjoint rotation. A torque-measuring device is connected at one connection point to the screwdriver housing via a torsionally elastic connection element, which comprises the torque-measuring device, and is rotatable in the screwdriver housing. The torque-measuring device detects the output torque of the output shaft as a reaction torque at the connection element. The invention further relates to a method for operating a screwdriver arrangement.

The present invention relates to a torque screwdriver arrangement with a screwdriver housing, a drive train arranged in the screwdriver housing and having a drive housing, a motor, in particular an electric motor, arranged in the drive housing and an output shaft, which projects out of the drive housing at its axially front end and whose axially front end comprises a bit holder for fixing a screw bit or can be connected to such a bit holder in a rotationally fixed manner, and the torque screwdriver arrangement further having a torque measuring device. Furthermore, the present invention relates to a method for operating a torque screwdriver arrangement.

Torque screwdriver arrangements for tightening and loosening screws are generally known. Such torque screwdriver arrangements are more and more frequently provided with a torque measuring device for detecting the screw tightening torque. For example, EP 2 127 812 A1 discloses a torque screwdriver arrangement comprising a screwdriver housing and a drive train disposed in the screwdriver housing. The drive train comprises a drive housing, an electric motor arranged in the drive housing and having an output shaft, a gearbox also arranged in the drive housing and connected to the electric motor via the output shaft thereof, and an output shaft of the gearbox, which projects out of the drive housing at the axially front end thereof and the axially front end of which can be connected in a rotationally fixed manner via a coupling mechanism to a bit holder for fixing a screwdriver bit. Furthermore, the torque screwdriver arrangement of EP 2 127 812 A1 comprises a torque measuring device arranged in the axial direction of the drive train between the electric motor and the gearbox. Specifically, strain gauges are applied to the outside of the drive housing in the area surrounding the output shaft of the electric motor, by means of which the screw tightening torque can be detected. As soon as the detected screw tightening torque reaches a predetermined value, the electric motor can be stopped accordingly. In addition, the area of the drive housing surrounding the electric motor is firmly connected to the screwdriver housing. In this way, during an operation of the torque screwdriver arrangement, the reaction torque exerted on the drive housing is supported over a large area. By means of the torque screwdriver arrangement of EP 2 127 812 A1, therefore, only a very inaccurate detection of the output torque and/or reaction torque is possible.

Against this background, the present invention is based on the task of providing a torque screwdriver arrangement of the type mentioned at the beginning, which enables the output torque of the output shaft to be detected as precisely as possible and, in addition, can be manufactured and operated inexpensively.

According to the invention, this task is solved in a torque screwdriver arrangement of the type mentioned at the beginning in that a support arrangement is provided at exactly one support location, via which the reaction torque exerted on the drive housing during operation of the torque screwdriver arrangement is supported on the screwdriver housing, and the drive housing is otherwise provided or mounted rotatably in the screwdriver housing, and in that the torque measuring device, which is provided in particular on the support arrangement, is designed and/or set up to detect the output torque of the output shaft in the form of the supported reaction torque on the support arrangement.

According to the invention, the aforementioned task is also solved by a method for operating a torque screwdriver arrangement of the type described above, in which

a) when a screw is turned by means of the torque screwdriver arrangement, a reaction torque is caused by the output torque of the output shaft, which reaction torque is exerted on the drive housing and is supported at exactly one support location on the screwdriver housing via the support arrangement, and
b) the torque measuring device detects the output torque of the output shaft in the form of the supported reaction torque at the support arrangement.

The invention is thus based on the consideration of supporting a reaction torque exerted on the drive housing at precisely one support location between the drive housing and the screwdriver housing via a support arrangement, and otherwise providing the drive housing in the screwdriver housing so as to be rotatable in particular about a longitudinal axis of the drive train. During an operation of the torque screwdriver arrangement according to the invention, the output torque occurring at the output shaft is transmitted from the output shaft via a drive mechanism and the drive housing of the drive train to the support arrangement, at which it can be detected as reaction torque. For example, the output torque is converted into a measurable rotational deflection of the support arrangement. Detection of the reaction torque is convenient because, in particular, measurement at the rotating output shaft, which is often associated with problems, can be dispensed with. The torque measuring device can be connected to or attached to the support arrangement. In principle, it is also possible that the support arrangement comprises at least a part of the torque measuring device. By detecting the reaction torque directly at the support arrangement and thus at the only support location of the reaction torque, the output torque of the output shaft can be detected much more precisely via the reaction torque compared to the previously known torque screwdriver arrangement. In addition, the torque screwdriver arrangement according to the invention can be manufactured and operated at a low cost. Furthermore, the torque detection at the support arrangement according to the invention offers the advantage of increased measurement accuracy and the possibility of measuring higher speeds compared to a torque detection by means of a detection of the motor current.

According to one embodiment of the invention, the support arrangement is arranged between an axial end of the drive housing, preferably an axial end face of the drive housing, and the screwdriver housing, and the drive housing is rotatably mounted in the screwdriver housing, in particular at its end axially opposite the support arrangement, preferably at the end face, via a bearing, in particular a rolling bearing, preferably a deep groove ball bearing. Via the rotatably mounted drive housing, in particular the entire drive train is rotatably mounted in the screwdriver housing. This rotatable mounting of the drive housing helps to stabilize the drive housing within the screwdriver housing at the same time, the reaction torque exerted on the drive housing is supported only at the axially opposite support location between the drive housing and the screwdriver housing via the support arrangement. For example, the support arrangement is located between the axially front end of the drive housing, preferably the axially front end face of the drive housing, and the screwdriver housing. In this case, the support and detection of the reaction torque takes place relatively close to the output shaft, which contributes to the most precise detection of the output torque possible.

The support arrangement can be connected to the screwdriver housing via an intermediate element. Preferably, the intermediate element is detachably connected, in particular screwed, to the support arrangement and/or the screwdriver housing. By using a suitable intermediate element, the support arrangement can be connected to screwdriver housings of different geometries. Screw connections are known to have the advantage of being detachable.

A further embodiment of the invention is characterized in that a coupling device is provided, via which a bit holder is connected to the output shaft, in particular to the axially front end of the output shaft, in a rotationally fixed manner but axially displaceably relative thereto. In this case, the coupling device is connected, preferably detachably connected, in particular screwed to the output shaft, and the axially rear end of the bit holder is in rotationally fixed but axially displaceable engagement with the coupling device. The bit holder can be guided axially displaceably at the axially front end of the screwdriver housing via a bearing arrangement comprising a bearing, in particular a plain bearing. The coupling device may be surrounded by a coupling device housing, which is arranged in the axially front end portion of the screwdriver housing and is detachably connected, preferably screwed thereto. In principle, however, the coupling device housing can also be formed integrally with the screwdriver housing. Expediently, elastic restoring means, such as a helical compression spring, disc spring and/or rubber spring, are provided, which are supported between the coupling device and the bit holder and press the bit holder into an axially forward starting position. Preferably, the elastic return means embrace the bit holder in order to be supported by the latter on the inside. The fact that the bit holder is axially displaceable relative to the output shaft against the restoring force of the elastic restoring means makes it possible, for example, to use a suitable measuring device to detect the contact force exerted on the bit holder, and as soon as the detected contact force reaches or exceeds the value of a desired release force, the motor of the torque screwdriver arrangement can be switched on accordingly. If an intermediate element is provided, the support arrangement may be connected to the screwdriver housing via the coupling device housing as the intermediate element.

In a preferred embodiment, the drive housing is connected to the screwdriver housing at the support location via the support arrangement. The support arrangement may include drive housing connecting means designed and/or set up to releasably connect the support arrangement to the drive housing. However, the support arrangement may also be fixedly connected to the drive housing. For example, the support arrangement may be welded, pressed and/or glued to the drive housing. It is also possible that the support arrangement is formed integrally with the drive housing. Likewise, the support arrangement may comprise screwdriver housing connecting means which are designed and/or set up to connect the support arrangement to the screwdriver housing or to an intermediate element provided between the screwdriver housing and the support arrangement, in particular in a detachable manner. In principle, the support arrangement can also be formed integrally with the intermediate element. Advantageously, the torque measuring device is designed and/or set up to detect the reaction torque axially between the screwdriver housing connecting means and the drive housing connecting means.

Advantageously, the support arrangement comprises an annular, in particular circular, fastening flange, which has through-holes between its two end faces, as drive housing connecting means, via which the fastening flange is connected to an end face of the drive housing. The annular fastening flange may be provided with radially inwardly projecting material reinforcements, preferably with a through-hole extending through each of these material reinforcements. Alternatively, the annular fastening flange may have a uniform thickness in the radial direction. Preferably, the through-holes are arranged in particular uniformly spaced apart from one another in the circumferential direction of the fastening flange. In the case of a uniform spacing of the through-holes, the fastening flange is attached to the drive housing with relatively uniform thickness in its circumferential direction. This can also contribute to the most precise detection of the output torque. The through holes can each be formed as stepped holes with a section of a smaller diameter on the drive housing side and an adjoining section of a larger diameter. This has the advantage, for example, that the head of a fastener extending through the stepped hole can be countersunk in the larger diameter section of the stepped hole. Preferably, the support arrangement comprises a central through-opening through which, in particular, a part of the output shaft extends and/or into which, in particular, the output shaft projects.

According to a further advantageous embodiment, the support arrangement is formed as a torsionally elastic support arrangement and comprises a sleeve in particular defining the central through-opening of the support arrangement, on which sleeve the screwdriver housing connecting means are formed, and an outer ring comprising the drive housing connecting means, which outer ring is formed in particular by the fastening flange and which radially surrounds the sleeve. In this case, the sleeve and the outer ring, in particular the fastening flange, are preferably torsionally elastically connected to one another via radial connecting webs, are preferably connected to one another exclusively via the radial connecting webs, and are otherwise spaced apart from one another by a gap, in particular an air gap. The gap may be at least partially filled with an elastic mass, thereby preventing contamination. Preferably, at least one connecting web comprises the torque measuring device or a part thereof or consists of the torque measuring device, or at least one connecting web is connected to the torque measuring device or a part thereof. This is particularly advantageous if the sleeve and the outer ring are connected to each other exclusively via the connecting webs, because in this case the reaction torque is supported exclusively via the connecting webs, which is why the reaction torque can be recorded particularly precisely by means of the torque measuring device at the connecting webs. It is expedient that at least one, preferably exactly one, connecting web is located in each case between two through-holes that are adjacent in the circumferential direction of the fastening flange. It is also possible not to provide a connecting web between at least one pair of through-holes adjacent in the circumferential direction of the fastening flange. For example, there may be two pairs of through-holes adjacent in the circumferential direction of the fastening flange, between each of which no connecting web is provided. Preferably, the two portions of the support arrangement where no connecting web is provided are radially opposite each other.

Preferably, the sleeve is connected at one axial end region, in particular at its axially rear end region, to the outer ring, in particular to the fastening flange, via the connecting webs and is provided at the opposite axial end region, in particular its axially front end region, with an internally or externally threaded section as screwdriver housing connecting means. Via the internally or externally threaded section, the torsionally elastic support arrangement can be in threaded engagement with an internally or externally threaded section corresponding thereto of the screwdriver housing or of an intermediate element provided between the torsionally elastic support arrangement and the screwdriver housing. In this case, the corresponding internally or externally threaded section is provided in particular at the axially rear end of the intermediate portion. Preferably, the sleeve is provided with an externally threaded section and the screwdriver housing or the intermediate element is provided with a correspondingly formed internally threaded section. A screw connection of this type can be quickly made and also loosened again.

The side faces of the connecting webs facing in the circumferential direction of the torsionally elastic support arrangement can be designed as planar surfaces. In addition, the connecting webs may each have an at least substantially uniform thickness in the circumferential direction of the torsionally elastic support arrangement. In general, it is advantageous if the connecting webs have a uniform or at least substantially uniform dimension. This is because this facilitates calibration of the torque measuring device and/or the torque screwdriver arrangement. In a preferred manner, the connecting webs are uniformly spaced apart from one another in the circumferential direction of the torsionally elastic support arrangement. This is particularly advantageous if the torque measuring device or parts thereof are integrated into or attached to the connecting webs, i.e. the measurement of the reaction torque takes place at the connecting webs. This is because in this case the output torque can be recorded particularly precisely due to the measuring points distributed uniformly along the circumference of the torsionally elastic connecting element.

According to a further advantageous embodiment, the torque measuring device comprises at least one strain gauge, which is arranged and/or connected in such a way that a torque can be measured therewith, and which is preferably connected according to the principle of the Wheatstone bridge to form one or more quarter, half and/or full bridges. Several bridges can be connected to one another in series, parallel and/or mixed. Strain gauges can be used to measure stretching and compressing deformations. This is because strain gauges change their electrical resistance even at low deformations. It is expedient that the strain gauge(s) is/are designed and/or arranged and/or connected in such a way that they change their electrical resistance in each case in the event of a deformation caused by a reaction torque and this change in resistance can be measured and, in turn, the acting torque can be derived from it. Preferably, the at least one strain gauge is applied to a side face of a connecting web facing in the circumferential direction of the torsionally elastic support arrangement. In particular, at least one strain gauge is applied to each of the side faces of the connecting webs facing in the circumferential direction of the torsionally elastic support arrangement.

A further embodiment of the invention is characterized in that the support arrangement has a drive housing side support element, on which the drive housing connecting means are provided, and a screwdriver housing side support element, on which the screwdriver housing connecting means are provided. In this case, one of the two support elements can be provided with at least one recess and the other support element can be provided with at least one projection corresponding thereto and projecting into the recess, a gap being formed in each case between two opposite side faces, facing in the circumferential direction of the support arrangement, of a recess and of an associated projection and the arrangement being made in such a way that the reaction torque in the circumferential direction of the support arrangement is supported between the side faces. Preferably, a part of the torque measuring device, in particular at least one piezoelectric element and/or piezoelectric sensor and/or piezoresistive sensor of the torque measuring device, is arranged in at least one gap. In this case, the part of the torque measuring device can be arranged, preferably fastened, to at least one of the two side surfaces in such a way that, when the width of the gap is reduced, when the two support elements are rotated relative to one another, a pressure is exerted on the part of the torque measuring device arranged in the gap, which pressure can be detected as an electrical signal. In this case, the electrical signal can be detected in particular by means of control electronics.

Advantageously, the drive housing side support element is formed as an annular fastening flange and/or the screwdriver housing side support element is formed as an annular plate. The at least one projection or the at least one recess can be arranged on the end face of the annular plate facing the drive housing side support element. A sleeve-like extension may be located on the opposite end face of the annular plate, which extension is arranged in particular coaxially with a central bore of the annular plate. The bore and the extension of the annular plate preferably form part of a central through-opening of the support arrangement, through which in particular a part of the output shaft extends and/or into which the output shaft projects. The sleeve-like extension may be provided with an internally or externally threaded section as screwdriver housing connecting means, via which the screwdriver housing side support element is in threaded engagement with a correspondingly formed internally or externally threaded section of the screwdriver housing or of an intermediate element provided between the screwdriver housing-side support element and the screwdriver housing.

Advantageously, the torque measuring device comprises at least one sensor, such as a resistance sensor and/or an electromagnetic sensor and/or a Hall sensor and/or a magnetoresistive sensor and/or a galvanomagnetic sensor and/or an optoelectronic sensor and/or a piezoelectric element and/or a piezoelectric sensor and/or a piezoresistive sensor. The torque measuring device can also comprise a sensor which is designed and/or set up to detect a torsion angle and/or a position and/or a deformation and/or a twist and/or a torsion and/or a shear force and/or a shear of the in particular torsionally elastic support arrangement, in particular of a region of the support arrangement, and/or of the drive housing. In the subsequent conversion of the measured values obtained by a sensor to the reaction torque, the material stiffness of the torsionally elastic support arrangement in particular can be taken into account.

A further embodiment of the invention is characterized in that the torque measuring device comprises at least two measuring device elements, which are designed and/or arranged in such a way that they are displaced relative to one another during a rotational deflection of the in particular torsionally elastic support arrangement. Preferably, at least one measuring device element is a sensor or a part of a sensor. The sensor may, for example, be one of the previously listed sensors. Particularly preferably, the measuring device elements are a magnetic field generating element and a magnetic field measuring element. The magnetic field measuring element may be, for example, a Hall sensor and/or a magnetoresistive element. The use of magnetic field generating and magnetic field measuring elements enables particularly precise detection of the output torque compared with other possible measuring device elements. In addition, magnetic field generating and magnetic field measuring elements can be mounted relatively easily.

If the support arrangement comprises a sleeve and an outer ring, in particular a fastening flange, which are connected to one another via connecting webs, a measuring device element of the torque measuring device is preferably arranged on a radially outer surface of the sleeve, in particular mounted on a pedestal. Preferably, the measuring device element is arranged on a radially outer surface of the axial end region of the sleeve where the sleeve is connected to the outer ring via the connecting webs, in particular mounted on a pedestal. Another measuring device element of the torque measuring device is preferably arranged on a radially inner surface of the outer ring, preferably of the annular fastening flange, in particular mounted on a pedestal. The arrangement of the one measuring device element on the sleeve and the other measuring device element on the outer ring can of course also be interchanged. Advantageously, the two measuring device elements of the torque measuring device are arranged opposite each other, but in particular do not touch each other. The torque measuring device can be designed and/or set up to detect a displacement of its two measuring device elements in the circumferential direction of the torsionally elastic support arrangement relative to one another when the sleeve and the outer ring, in particular the fastening flange, rotate relative to each other. An arrangement of two opposing measuring device elements of the torque measuring device may be provided instead of a connecting web. Furthermore, the arrangement may be positioned in the circumferential direction of the torsionally elastic support arrangement, in particular between two adjacent through-holes of the fastening flange. Preferably, no connecting web is provided in a region of the torsionally elastic support arrangement directly radially opposite the arrangement.

According to a further embodiment, the drive train has a gearbox, which adjoins the axially front end of the motor and is arranged in the drive housing. In this case, the drive housing can be of two-part design, with the motor being arranged in a first, in particular axially rear, part of the drive housing and the gearbox being arranged in a second, in particular axially front, part of the drive housing. Furthermore, the drive housing can be separated from the screwdriver housing in the radial direction by a gap, in particular an air gap. This supports the rotatable mounting of the drive housing in the screwdriver housing.

A further embodiment of the invention is characterized in that a control electronics is provided which is coupled to the torque measuring device and the motor in order to switch off the motor dependent from output signals of the torque measuring device. Thus, the motor of the torque screwdriver arrangement can be switched off automatically as soon as a predetermined target torque is reached or exceeded, thus avoiding damage to a screw connection made by means of the torque screwdriver arrangement. The control electronics may be an internal control electronics arranged on the screwdriver housing, in particular arranged at least partially, optionally completely, within the screwdriver housing, an external control electronics arranged remotely from the screwdriver housing, and/or a higher-level controller. Furthermore, the control electronics may comprise a memory, in particular a RAM memory, for storing a plurality of predefined target torques and/or a user interface or a setting and/or input means, in particular a touch-sensitive screen, a jogwheel and/or a membrane keyboard, for setting a target torque in particular stored in the memory. Furthermore, it may be provided that the torque of the motor is adjustable and/or storable via a potentiometer, in particular directly on an electric screwdriver of the torque screwdriver arrangement.

Further features and advantages of the present invention will become apparent from the following description of four embodiments of a torque screwdriver arrangement according to the present invention, with reference to the accompanying drawing. Therein is:

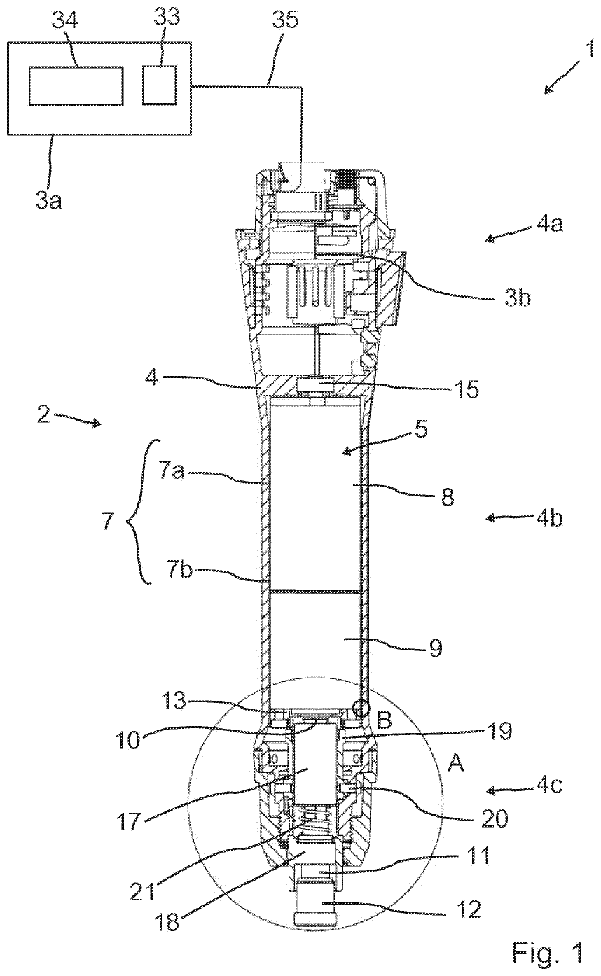

FIG. 1 a schematic partial sectional view of a torque screwdriver arrangement according to a first embodiment of the present invention;

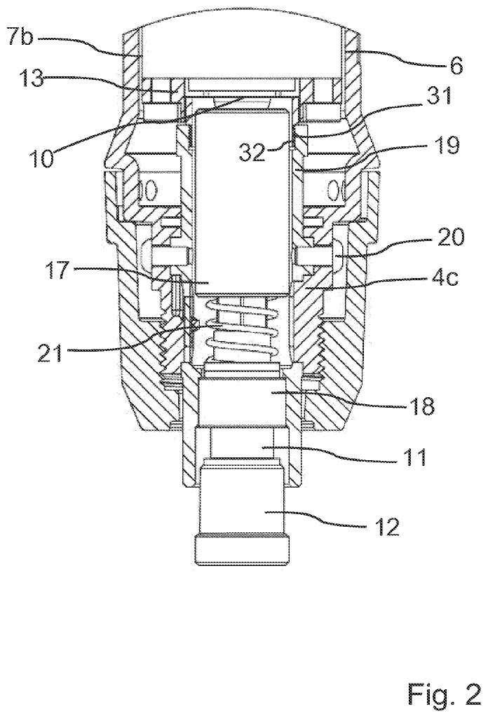

FIG. 2 an enlarged view of the area of the torque screwdriver arrangement marked with the letter “A” in FIG. 1;

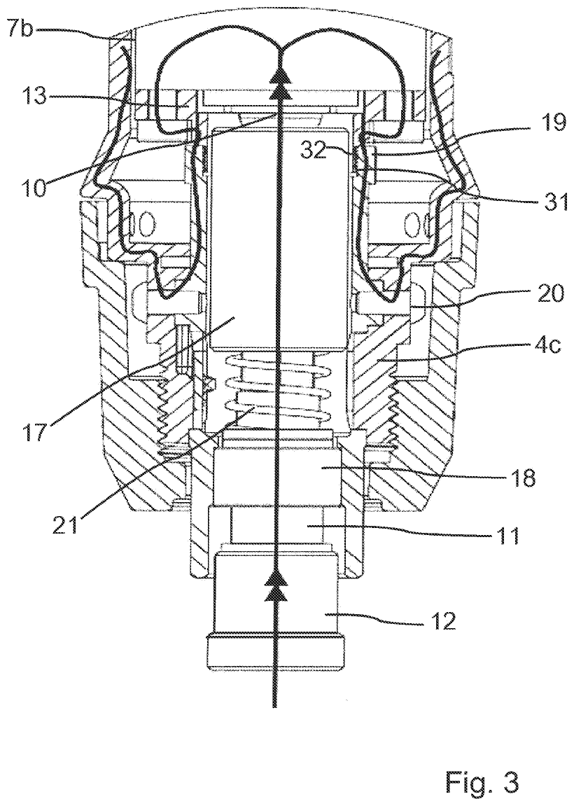

FIG. 3 an enlarged view of the area of the torque screwdriver arrangement marked with the letter “A” in FIG. 1 with an additional torque transmission path drawn in;

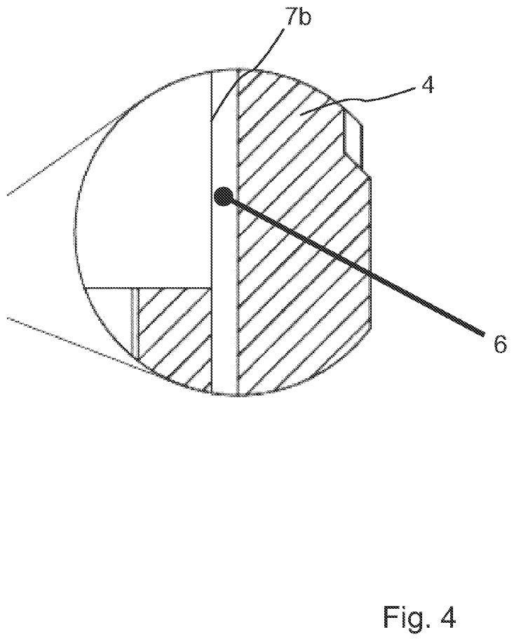

FIG. 4 an enlarged view of the area of the torque screwdriver arrangement marked with the letter “B” in FIG. 1;

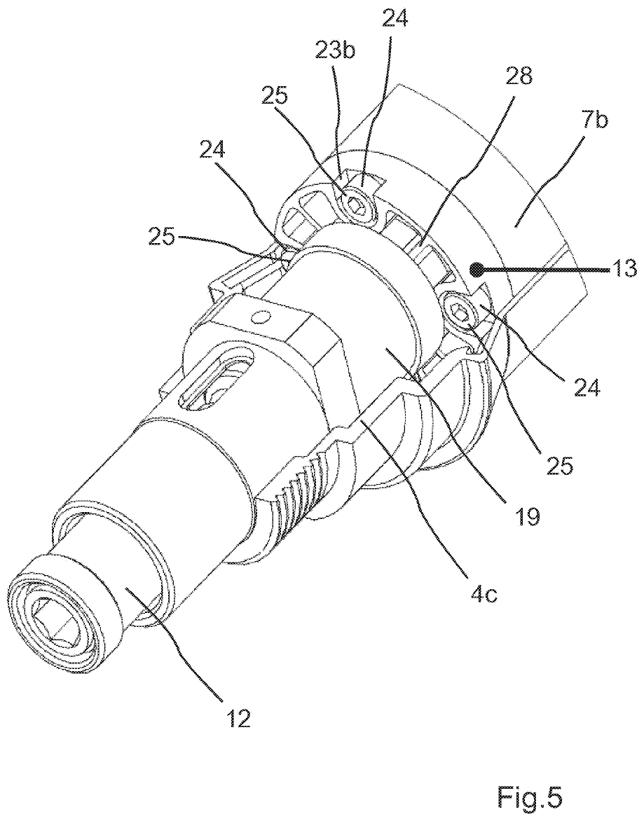

FIG. 5 a perspective view of an axially forward portion of the screwdriver arrangement according to the first embodiment;

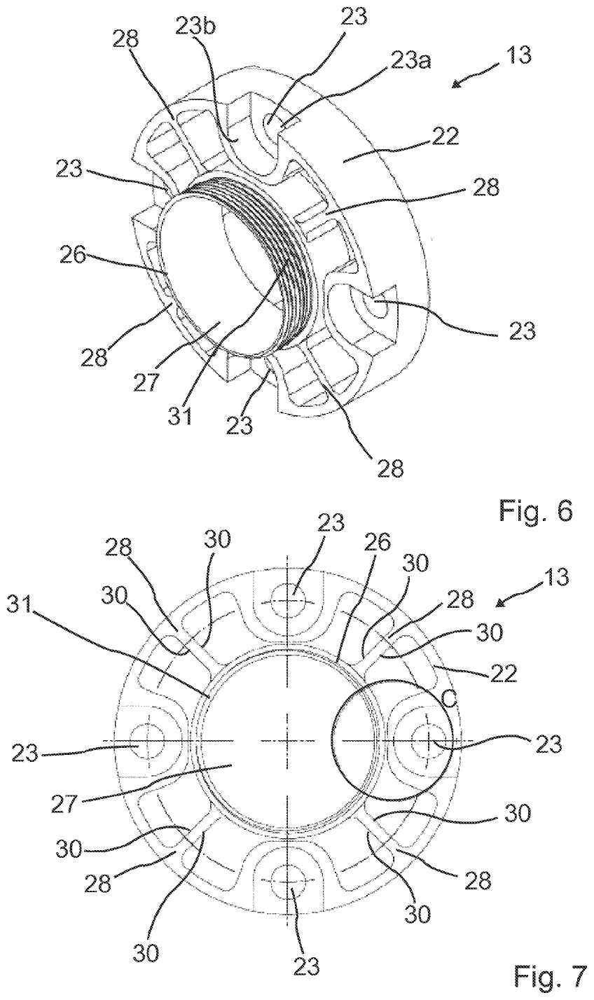

FIG. 6 a perspective view of a torsionally elastic support arrangement of the torque screwdriver arrangement according to the first embodiment;

FIG. 7 a front view of the torsionally elastic support arrangement of FIG. 6;

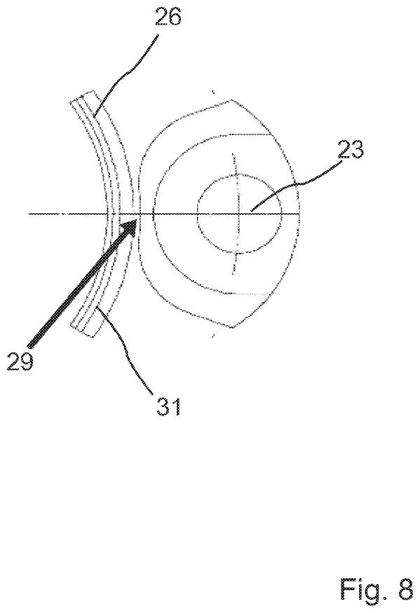

FIG. 8 an enlarged view of the area of the torsionally elastic support arrangement marked with the letter “C” in FIG. 7;

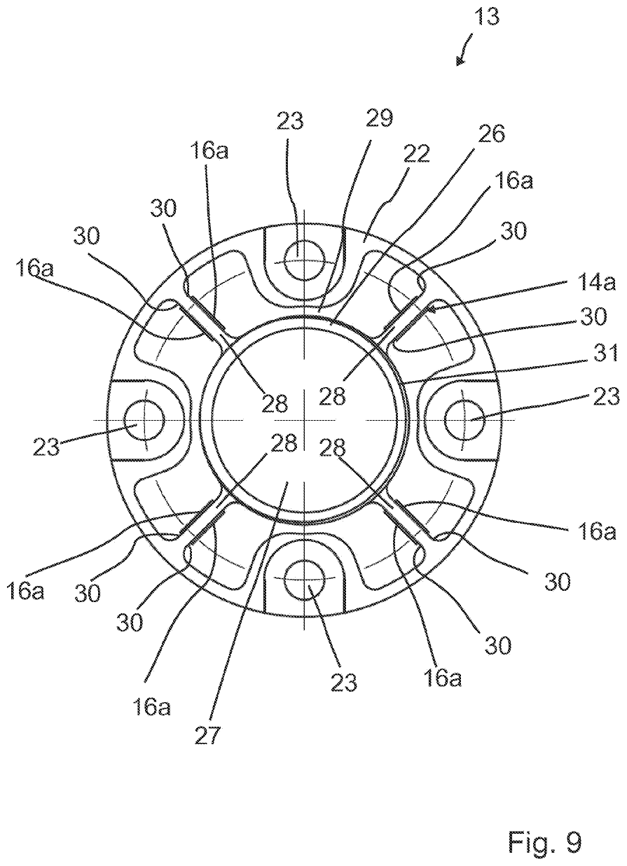

FIG. 9 a further front view of the torsionally elastic support arrangement of FIG. 6;

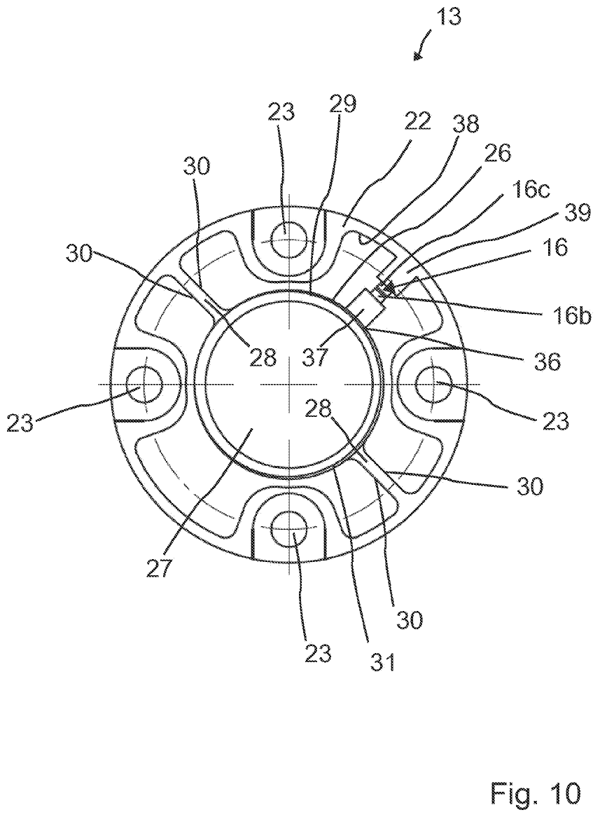

FIG. 10 a front view of a torsionally elastic support arrangement of a torque screwdriver arrangement according to a second embodiment of the present invention;

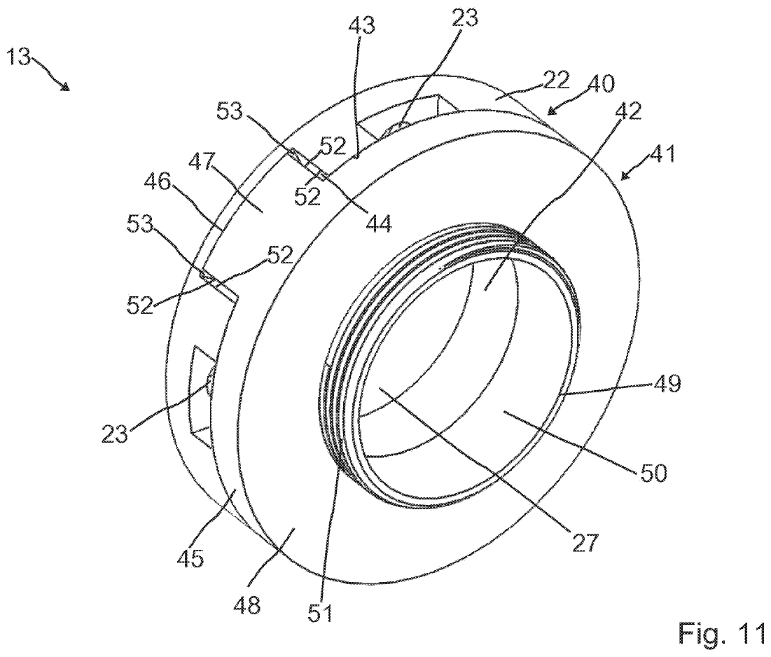

FIG. 11 a perspective view of a support arrangement of a torque screwdriver arrangement according to a third embodiment of the present invention;

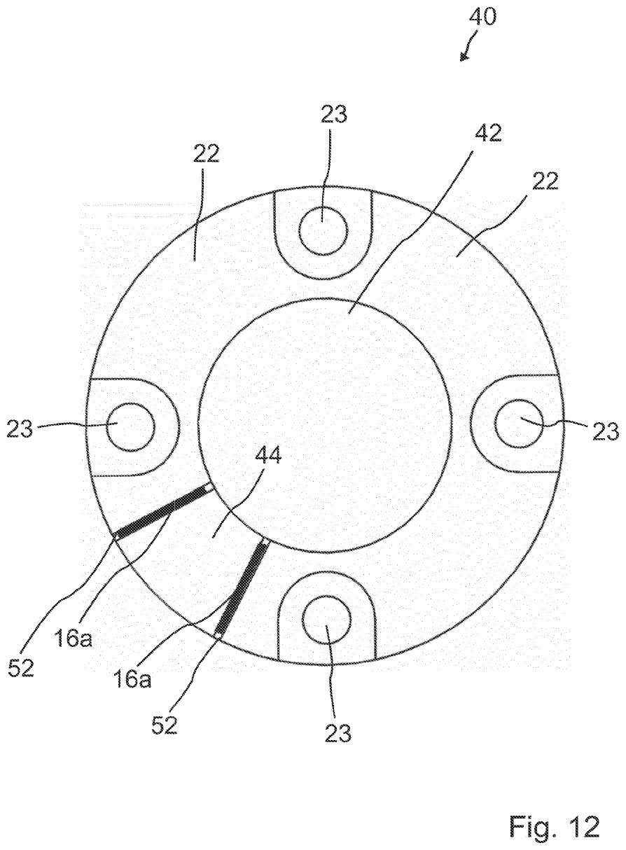

FIG. 12 a front view of a drive housing side support element of the support arrangement of FIG. 11;

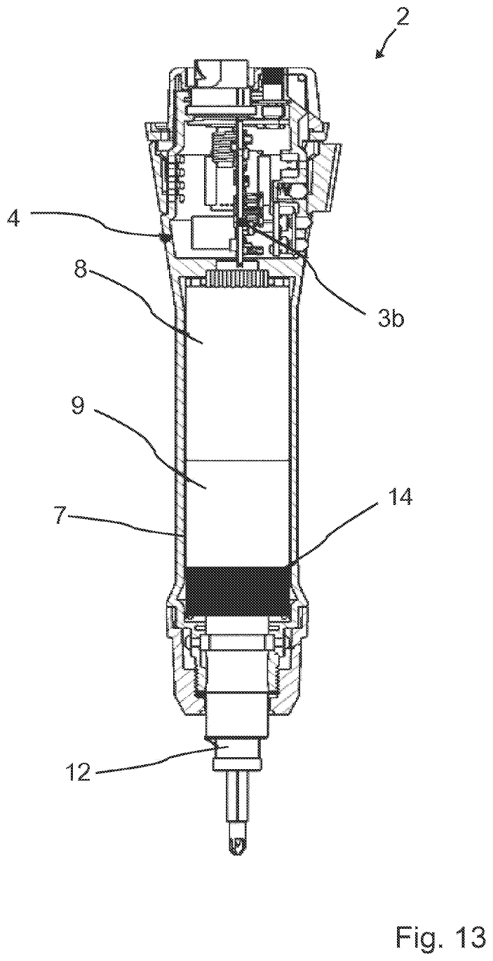

FIG. 13 a schematic partial sectional view of the torque screwdriver arrangement according to the first, second and third embodiments with indicated position of a support location between the drive housing and the screwdriver housing;

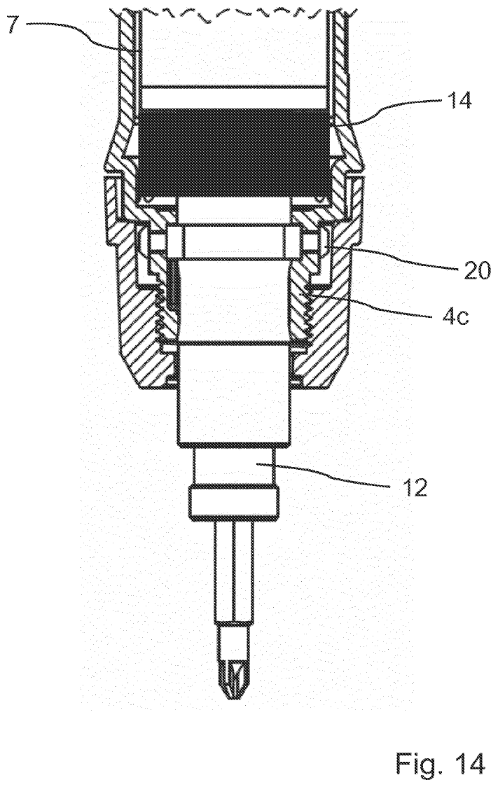

FIG. 14 an enlarged view of the axially forward portion of the torque screwdriver arrangement of FIG. 13;

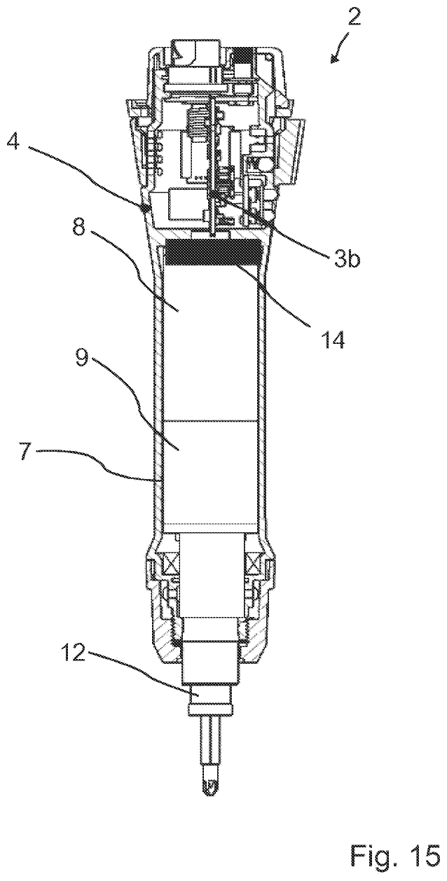

FIG. 15 is a schematic partial sectional view of a torque screwdriver arrangement according to a fourth embodiment of the present invention; and

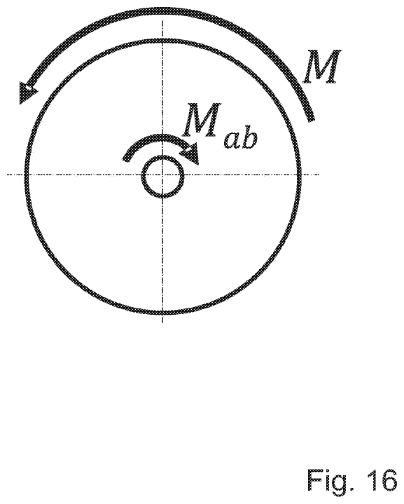

FIG. 16 an illustration of the reaction torque with respect to the output torque.

FIGS. 1 to 9 illustrate a torque screwdriver arrangement 1 according to a first embodiment of the present invention. The torque screwdriver arrangement 1 comprises an electric screwdriver 2 and external control electronics 3a connected thereto. The electric screwdriver 2 includes a screwdriver housing 4 comprising an axially front housing portion 4a, a middle housing portion 4b and an axially rear housing portion 4c.

Furthermore, the electric screwdriver 2 has a drive train 5 arranged in the middle and axially front housing portion 4a, 4b of the screwdriver housing 4. This has a two-part drive housing 7 separated in the radial direction from the screwdriver housing 4 by a gap 6, here an air gap, a motor 8 in the form of an electric motor arranged in an axially rear part 7a of the drive housing 7, a gearbox 9 arranged in an axially front part 7b of the drive housing 7 and connected to the motor 8, and an output shaft 10 of the gearbox 9. The output shaft 10 projects from the drive housing 7 at the axially front end thereof. The axially front end of the output shaft 10 is connected in a rotationally fixed manner to a bit holder 11 with a bit receptacle 12 for fixing a screw bit not shown. Furthermore, the electric screwdriver 2 comprises a torsionally elastic support arrangement 13, which is provided at exactly one support location 14 and via which the reaction torque exerted on the drive housing 7 during operation of the torque screwdriver arrangement 1 is supported on the screwdriver housing 4. The drive housing 7 is connected to the screwdriver housing 4 at the support location 14 via the torsionally elastic support arrangement 13, and is otherwise rotatably provided in the screwdriver housing 4. More specifically, the torsionally elastic support arrangement 13 is arranged between the axially front end face of the drive housing 7 and the screwdriver housing 4, and the drive housing 7 is presently rotatably supported in the screwdriver housing 4 at its axially rear end face via a roller bearing, in this case a deep groove ball bearing 15.

Furthermore, the electric screwdriver 2 is equipped with a torque measuring device 16 with eight strain gauges 16a. The torque measuring device 16 is designed and/or set up to detect the output torque of the output shaft 10 in the form of the supported reaction torque at the torsionally elastic support arrangement 13.

Furthermore, the electric screwdriver 2 comprises a coupling device 17, via which the bit holder 11 is connected to the axially front end of the output shaft 10 in a rotationally fixed manner but axially displaceably relative thereto. For this purpose, the axially rear end of the bit holder 11 is in rotationally fixed but axially displaceable engagement with the coupling device 17. In the present case, the bit holder 11 is guided axially displaceably at the axially front end of the screwdriver housing 4 via a bearing arrangement 18 comprising a plain bearing. The coupling device 17 is detachably connected to the output shaft 10. Furthermore, the coupling device 17 is surrounded by a coupling device housing 19 which is arranged in the axially front housing section 4a of the screwdriver housing 4 and is detachably connected thereto, more specifically screwed at a screw connection point 20. The bit holder 11 is pressed into an axially forward starting position by elastic restoring means 21 in the form of a helical compression spring. Specifically, the helical compression spring is supported axially between a front end face of the coupling device 17 and a rear end face of the bit holder 11, being placed on the axially rear end portion of the bit holder 11 so that it embraces the latter and is supported internally by the latter.

The torsionally elastic support arrangement 13 has an outer ring formed by an annular fastening flange 22. The fastening flange 22 is provided between its two end faces with four through-holes 23 as drive housing connecting means, via which the fastening flange 22 is detachably connected to the axially front end face of the drive housing 7. The through holes 23 each extend through a region of the fastening flange 22 at which the latter is reinforced by means of radially inwardly projecting material reinforcements. Specifically, the fastening flange 22 is bolted to the drive housing 7 by means of fastening screws 24 extending through the through holes 23. The through holes 23 are uniformly spaced from each other in the circumferential direction of the fastening flange 22, and are formed as stepped holes with a smaller diameter section 23a on the drive housing side and an adjoining larger diameter section 23b. As can be seen in particular in FIG. 5, the screw heads 25 of the fastening screws 24 are each countersunk in one of the larger diameter sections 23a.

Further, the torsionally elastic support arrangement 13 includes a sleeve 26 defining a central through-opening 27 of the torsionally elastic support arrangement 13 through which the output shaft 10 extends. The sleeve 26 is radially surrounded by the fastening flange 22 and is connected at its axially rear end region to the fastening flange 22 by four radial connecting webs 28. In principle, however, the sleeve 26 can be connected to the fastening flange 22 via any number of connecting webs 28. In this case, the sleeve 26 and the fastening flange 22 are connected to each other exclusively via the connecting webs 28 and are otherwise spaced apart by a gap 29, in this case an air gap. The gap 29 may be at least partially filled with an elastic mass. Exactly one connecting web 28 is located centrally in each case between two through-holes 23 adjacent in the circumferential direction of the fastening flange 22. An off-center arrangement of the connecting webs 28 is also possible. The connecting webs 28 are thus uniformly spaced from one another in the circumferential direction of the torsionally elastic support arrangement 13. Furthermore, the connecting webs 28 each have a uniform thickness in the circumferential direction of the torsionally elastic support arrangement 13. In general, however, the thickness need not be uniform. The side faces 30 of the connecting webs 28 facing in the circumferential direction of the torsionally elastic support arrangement 13 are formed as planar surfaces.

In addition, the sleeve 26 is provided at its axially front end region with an externally threaded section 31 as a screwdriver housing connecting means. Via the externally threaded section 31, the sleeve 26 is in threaded engagement with a correspondingly formed internally threaded section 32 at the axially rear end of the coupling device housing 19. In this manner, the torsionally elastic support arrangement 13 is connected to the screwdriver housing 4 via the coupling device housing 19 as an intermediate element.

Furthermore, the torque measuring device 16 is connected to the torsionally elastic support arrangement 13 and is designed and/or set up to detect the reaction torque axially between the screwdriver housing connecting means and the drive housing connecting means. For this purpose, a strain gauge 16a is presently applied to each side face 30 of the connecting webs 28. The strain gauges 16a are connected in such a way that a reaction torque can be measured therewith. In a further embodiment not shown here, a single strain gauge 16a may be provided which is applied to a side face 30 of one of the connecting webs 28.

Furthermore, the electric screwdriver 2 comprises an internal control electronics 3b, which together with the external control electronics 3a is referred to as the control electronics 3 of the screwdriver arrangement 1. The internal control electronics 3b is arranged within the axially rear housing portion 4c of the screwdriver housing 4. The external control electronics 3a is located outside the electric screwdriver 2 and comprises a memory 33 with predefined target torques stored therein and a user interface 34 in the form of a touch-sensitive screen. The internal control electronics 3b is connected to the external control electronics 3a at the axially rear end of the screwdriver housing 4 via a transmission line 35. The control electronics 3 are coupled to the torque measuring device 16 and the motor 8 to switch off the motor 8 in response to output signals from the torque measuring device 16. In a further embodiment not shown here, the torque screwdriver arrangement 1 has only internal control electronics 3b and no external control electronics 3a. In this case, the internal control electronics 3b can take over the tasks of the external control electronics 3a. For this purpose, the internal control electronics 3b can comprise the memory 33 and/or the user interface 34.

FIG. 10 shows a torsionally elastic support arrangement 13 of a torque screwdriver arrangement 1 according to a second embodiment of the present invention. The second embodiment is substantially identical to the first embodiment, and therefore only the differences between the second embodiment and the first embodiment will be discussed below.

The second embodiment differs from the first embodiment only in that the design of the torsionally elastic support arrangement 13 is slightly different, because the sleeve 26 of the torsionally elastic support arrangement 13 is connected at its axially rear end region to the fastening flange 22 of the torsionally elastic support arrangement 13 only via two radial connecting webs 28 instead of four. Here, the two connecting webs 28 are radially opposite each other. Thus, no connecting webs 28 are provided between two pairs of through-holes 23 adjacent in the circumferential direction of the fastening flange 22. These regions without connecting webs 28 are also radially opposite each other. Moreover, the torque measuring device 16 does not comprise strain gauges 16a, but instead comprises two measuring device elements which are a magnetic field generating element, in this case a magnet 16b, and a magnetic field measuring element, in this case a Hall sensor 16c. The magnet 16b is arranged mounted on a radially outer surface 36 of the sleeve 26 on a pedestal 37, and the Hall sensor 16c is arranged mounted on a radially inner surface 38 of the annular fastening flange 22 on a further pedestal 39. In a further embodiment not shown here, the magnet 16b may be arranged on the surface 38 and the Hall sensor 16c may be arranged on the surface 36 mounted on a respective pedestal 37, 39. The magnet 16b and the Hall sensor 16c are directly opposite each other, but do not touch. The arrangement of the two pedestals 37, 39, the magnet 16c and the Hall sensor 16c is at a position where, in the first embodiment, a further connecting web 28 is provided.

FIGS. 11 and 12 show a support arrangement 13 of a torque screwdriver arrangement 1 according to a third embodiment of the present invention. The third embodiment is substantially identical to the first and second embodiments, and therefore only the differences between the third embodiment and the first and second embodiments will be discussed below.

The third embodiment differs from the first and second embodiments only in a modified design of the support arrangement 13, which in the third embodiment comprises two separate elements, which is why the drive housing 7 is not connected to the screwdriver housing 4 via the support arrangement 13. More specifically, the support arrangement 13 has a drive housing side support element 40 and a screwdriver housing side support element 41, which bear against each other with their mutually facing end faces 43, 46. The drive housing side support element 40 is formed as an annular fastening flange 22 with four through-holes 23 as drive housing connecting means and a central bore 42. In addition, the drive housing side support element 40 is provided with a recess 44 at its end face 43 facing the screwdriver housing side support element 41. The screwdriver housing side support element 41 is designed as an annular plate 45, on whose end face 46 facing the drive housing side support element 40 a projection 47 is arranged which corresponds to the recess 44 and projects into it. On the opposite end face 48 of the annular plate 45, there is a sleeve-like extension 49 which is arranged coaxially with a central bore 50 of the annular plate 45. Here, the central bore 50 of the annular plate 45, the extension 49 and the central bore 42 of the fastening flange 22 form the central through-opening 27 of the support arrangement 13. The sleeve-like extension 49 is provided with an externally threaded section 51 as a screwdriver housing connecting means, via which the screwdriver housing side support element 41 is in threaded engagement with the correspondingly formed internally threaded section 32 at the axially rear end of the coupling device housing 19.

In the third embodiment, a gap 53 is formed between each of two opposing side faces 52 of the recess 44 and the projection 47 facing in the circumferential direction of the support arrangement 13. The arrangement is such that the support of the reaction torque in the circumferential direction of the support arrangement 13 takes place between the side faces 52. In the present case, therefore, there are a total of two gaps 53, in each of which a piezoelectric element 16d of the torque measuring device 16 is arranged. Thus, on the support arrangement 13 according to the third embodiment, piezoelectric elements 16d are provided instead of strain gauges 16a and instead of a magnet 16b and a Hall sensor 16c, respectively. More specifically, the two piezoelectric elements 16d are each attached to a side face 52 of a gap 53 belonging to the drive housing side support element 40.

FIGS. 13 and 14 show schematic partial sectional views of the torque screwdriver arrangement 1 according to the first, second and third embodiments. These are intended only to illustrate the location of the support location 14. In the case of the first, second and third embodiments, the support location 14 is located at the axially front end of the drive housing 7. Specifically, the support arrangement 13 is arranged between the axially front end of the drive housing 7 and the screwdriver housing 4.

FIG. 15 shows a schematic partial sectional view of a torque screwdriver arrangement 1 according to a fourth embodiment of the present invention. The fourth embodiment differs from the first, second and third embodiments in that the support location 14 is at the axially rear end of the drive housing 7. The support arrangement 13, via which the reaction torque exerted on the drive housing 7 is supported at the support location 14 on the screwdriver housing 4, is for example one of the support arrangements 13 described in connection with the first three embodiments. In the fourth embodiment of the invention, the drive housing 7 is correspondingly rotatably mounted at its axially front end in the screwdriver housing 4.

The torque screwdriver arrangement 1 according to the invention in accordance with the four embodiments described above can be operated in accordance with the method explained below.

At the external control electronics 3a, a user may first set a desired target torque via the user interface 34 by entering the desired target torque or selecting from a plurality of predefined selections stored in the memory 33. Subsequently, the screwdriver 2 is pressed by the user with a screw bit fixed in the bit holder 12 of the bit holder 11 against a screw to be turned and the screwdriver 2 is activated either automatically when a desired contact force is reached or manually by the user, i.e. the motor 8 is switched on. For the sake of clarity, neither the screw bit nor the screw are shown in the figures.

When the screw is turned by means of the screwdriver 2, the output torque of the output shaft 10 causes a reaction torque to be exerted on the drive housing 7, which is supported at the support location between the drive housing 7 and the screwdriver housing 4 via the support arrangement 13. By means of the torque measuring device 16, the output torque of the output shaft 10 is detected in the form of the supported reaction torque at the support arrangement 13. For example, in the case of the first embodiment of the invention, thus in the case of the use of strain gauges 16a, the torque detection is performed by measuring a deformation of the torsionally elastic support arrangement 13, in particular of the connecting webs 28 or of the fastening flange 22. For example, in the case of the second embodiment of the invention, thus in the case of the use of a magnet 16b and a Hall sensor 16c, the torque detection is performed by measuring a displacement and/or a rotation of the magnet 16b and the Hall sensor 16c in the circumferential direction of the torsionally elastic support arrangement 13 relative to each other during a rotational deflection of the torsionally elastic support arrangement 13, thus a rotation of the sleeve 26 and the fastening flange 22 relative to each other. In the case of the third embodiment of the invention, i.e. in the case of the use of piezoelectric elements 16d, torque detection is performed by exerting a pressure on the piezoelectric element 16d arranged in the gap 53 when the width of a gap 53 is reduced during a rotation of the two support elements 40, 41 relative to each other, which pressure is detectable as an electrical signal. In this way, the output torque can be detected much more precisely via the reaction torque compared to previously known torque wrench arrangements. If required, the measurement can still be compared with a detected motor current of the motor 8.

The detected reaction torque is then compared with the preset desired target torque by means of the control electronics 3. As soon as the target torque is reached or exceeded, the control electronics 3 causes the motor 8 to be switched off automatically. In this way, damage to a screw connection produced by means of the torque screwdriver arrangement 1 can be avoided.

If required, a calibration of the torque screwdriver arrangement 1 can be carried out in particular via the control electronics 3. In this case, a certified measuring method is used, which is compared with the recorded measured values from the screwdriver 2. Depending on the level of deviation of the measured values, the recorded measured values of the screwdriver 2 are then adjusted.

FIG. 16 shows the relationship between the output torque M_{ab} of the output shaft 10 and the reaction torque M detected by means of the torque measuring device 16, where: M=−M_{ab}

### REFERENCE SIGN LIST

1 torque screwdriver arrangement
2 screwdriver
3 control electronics
3a external control electronics
3b internal control electronics
4 screwdriver housing
4a axial front housing portion
4b middle housing portion
4c axial rear housing portion
5 drive train
6 gap
7 drive housing
7a axial rear part of drive housing
7b axial front part of drive housing
8 motor
9 gearbox
10 output shaft
11 bit holder
12 bit receptacle
13 support arrangement
14 support location
15 roller bearing
16 torque measuring device
16a strain gauge
16b magnet
16c Hall sensor
16d piezoelectric element
17 coupling device
18 bearing arrangement
19 coupling device housing
20 screw connection point
21 elastic restoring means
22 fastening flange
23 through-hole
23a smaller diameter section
23b larger diameter section
24 fastening screw
25 screw head
26 sleeve
27 central through-opening
28 connecting web
29 gap
30 side face
31 externally threaded section
32 internally threaded section
33 memory
34 user interface
35 transmission line
36 surface
37 pedestal
38 surface
39 pedestal
40 drive housing side support element
41 screwdriver housing side support element
42 central bore of mounting flange
43 end face
44 recess
45 annular plate
46 end face
47 projection
48 end face
49 sleeve-like extension
50 central bore
51 externally threaded section
52 side face
53 gap

1. Torque screwdriver arrangement (1) with a screwdriver housing (4), a drive train (5) arranged in the screwdriver housing (4), which drive train (5) has a drive housing (7), a motor (8), in particular an electric motor, arranged in the drive housing (7) and an output shaft (10), which projects out of the drive housing (7) at its axially front end face and whose axially front end comprises a bit holder (11) for fixing a screw bit or can be connected in a rotatably fixed manner to such a bit holder, the torque screwdriver arrangement (1) further having a torque measuring device (16), wherein a support arrangement (13) is provided at exactly one support location (14), via which the reaction torque exerted on the drive housing (7) during operation of the torque screwdriver arrangement (1) is supported on the screwdriver housing (4), and the drive housing (7) is otherwise provided or mounted rotatably in the screwdriver housing (4), and wherein the torque measuring device (16), which is provided in particular on the support arrangement (13), is designed and/or set up to detect the output torque of the output shaft (10) in the form of the supported reaction torque on the support arrangement (13).

2. Torque screwdriver arrangement (1) according to claim 1, wherein the support arrangement (13) is arranged between an axial end of the drive housing (7), preferably an axial end face of the drive housing (7), and the screwdriver housing (4), and the drive housing (7) is rotatably mounted, in particular at its end axially opposite the support arrangement (13), preferably at the end face, via a bearing, in particular a roller bearing (15), preferably a deep groove ball bearing in the screwdriver housing (4).

3. Torque screwdriver arrangement (1) according to claim 1, wherein the support arrangement (13) is connected to the screwdriver housing (4) via an intermediate element, the intermediate element preferably being detachably connected, in particular screwed, to the support arrangement (13) and/or the screwdriver housing (4).

4. Torque screwdriver arrangement (1) according to claim 1, wherein a coupling device (17) is provided, via which a bit holder (11) is connected to the output shaft (10), in particular to the axially front end of the output shaft (10), in a rotationally fixed manner but axially displaceably relative thereto, the coupling device (17) being connected, preferably releasably connected, in particular screwed, to the output shaft (10) and the axially rear end of the bit holder (11) being in rotationally fixed but axially displaceable engagement with the coupling device (17), and wherein the coupling device (17) is in particular surrounded by a coupling device housing (19), which is arranged in the axially front end portion of the screwdriver housing (4) and is releasably connected, preferably screwed thereto.

5. Torque screwdriver arrangement (1) according to claim 4, wherein elastic restoring means (21), such as a helical compression spring, disc spring and/or rubber spring are provided, which are supported between the coupling device (17) and the bit holder (11) and press the bit holder (11) into an axially forward starting position, the elastic restoring means (21) preferably embracing the bit holder (11) in order to be supported by the latter on the inside.

6. Torque screwdriver arrangement (1) according to claim 3, wherein the support arrangement (13) is connected to the screwdriver housing (4) via the coupling device housing (19) as intermediate element.

7. Torque screwdriver arrangement (1) according to claim 1, wherein the drive housing (7) is connected to the screwdriver housing (4) at the support location (14) via the support arrangement (13), the support arrangement (13) having, in particular, drive housing connecting means which are designed and/or set up to connect the support arrangement (13) releasably to the drive housing (7), and/or comprising screwdriver housing connecting means, which are designed and/or set up to connect the support arrangement (13) to the screwdriver housing (4) or to an intermediate element provided between the screwdriver housing (4) and the support arrangement (13), and wherein the torque measuring device (16) is in particular designed and/or set up to the detect the reaction torque axially between the screwdriver housing connecting means and the drive housing connecting means.

8. Torque screwdriver arrangement (1) according to claim 7, wherein the support arrangement (13) comprises an annular, in particular circular, fastening flange (22), which has through-holes (23) between its two end faces, as drive housing connecting means, via which the fastening flange (22) is connected to an end face of the drive housing (7) and which are preferably arranged in the circumferential direction of the fastening flange (22) in particular uniformly spaced apart from one another, and the support arrangement (13) preferably comprises a central through-opening (27) through which in particular a part of the output shaft (10) extends and/or into which the output shaft (10) in particular projects.

9. Torque screwdriver arrangement (1) according to claim 8, wherein the through-holes (23) are each formed as stepped holes with a section (23a) of a smaller diameter on the drive housing side and a section (23b) of a larger diameter adjoining it.

10. Torque screwdriver arrangement (1) according to claim 7, wherein the support arrangement (13) is formed as a torsionally elastic support arrangement (13) and comprises a sleeve (26) in particular defining the central through-opening (27) of the torsionally elastic support arrangement (13), on which sleeve (26) the screwdriver housing connecting means are formed, and an outer ring comprising the drive housing connecting means, which outer ring is formed in particular by the fastening flange (22) and which radially surrounds the sleeve (26), wherein the sleeve (26) and the outer ring, in particular the fastening flange (22), are preferably torsionally elastically connected to one another via radial connecting webs (28), are preferably connected to one another exclusively via the radial connecting webs (28) and are otherwise spaced apart from one another by a gap (29), and wherein the gap (29) is in particular at least partially filled with an elastic mass.

11. Torque screwdriver arrangement (1) according to claim 10, wherein at least one connecting web (28) comprises the torque measuring device (16) or a part thereof or consists of the torque measuring device (16) or is connected to the torque measuring device (16) or a part thereof.

12. Torque screwdriver arrangement (1) according to claim 8, wherein one, preferably exactly one connecting web (28) is located in each case between two through-holes (23) adjacent in the circumferential direction of the fastening flange (22).

13. Torque screwdriver arrangement (1) according to claim 10, wherein the sleeve (26) is connected at one axial end region, in particular at its axially rear end region, to the outer ring, in particular to the fastening flange (22), via the connecting webs (28) and is provided at the opposite axial end region, in particular its axially front end region, with an internally or externally threaded section (31) as screwdriver housing connecting means, via which the torsionally elastic support arrangement (13) is in threaded engagement with an internally or externally threaded section (32), corresponding thereto, of the screwdriver housing (4) or of an intermediate element provided between the torsionally elastic support arrangement (13) and the screwdriver housing (4), the corresponding internally or externally threaded section (32) being provided in particular at the axially rear end of the intermediate portion.

14. Torque screwdriver arrangement (1) according to claim 10, wherein side faces (30) of the connecting webs (28) facing in the circumferential direction of the torsionally elastic support arrangement (13) are designed as planar surfaces and/or the connecting webs (28) each have at least a substantially uniform thickness in the circumferential direction of the torsionally support arrangement (13) and/or the connecting webs (28) are arranged uniformly spaced apart from one another in the circumferential direction of the torsionally elastic support arrangement (13).

15. Torque screwdriver arrangement (1) according to claim 1, wherein the torque measuring device (16) comprises at least one strain gauge (16a), which is arranged and/or connected in such a way that a torque can be measured therewith and which is preferably connected according to the principle of the Wheatstone bridge to form one or more quarter, half and/or full bridges, a plurality of bridges in particular being connected to one another in series, in parallel and/or mixed.

16. Torque screwdriver arrangement (1) according to claim 15, wherein the at least one strain gauge (16a) is applied to a side face (30) of a connecting web (28) facing in the circumferential direction of the torsionally elastic support arrangement (13), in particular at least one strain gauge (16a) being applied to the side faces (30) of the connecting webs (28) facing in the circumferential direction of the torsionally elastic support arrangement (13), respectively.

17. Torque screwdriver arrangement (1) according to claim 7, wherein the support arrangement (13) has a drive housing side support element (40), on which the drive housing connecting means are provided, and a screwdriver housing side support element (41), on which the screwdriver housing connecting means are provided, and one of the two support elements (40, 41) is provided with at least one recess (44) and the other support element (40, 41) is provided with at least one projection (47) corresponding thereto and projecting into the recess (44), a gap (53) being formed in each case between two opposite side faces (52), facing in the circumferential of the support arrangement (13), of a recess (44) and of an associated projection (47) and the arrangement being made in such a way that the reaction torque is supported in the circumferential direction of the support arrangement (13) between the side faces (52).

18. Torque screwdriver arrangement (1) according to claim 17, wherein a part of the torque measuring device (16), in particular at least one piezoelectric element (16d) and/or piezoelectric sensor and/or piezoresistive sensor of the torque measuring device (16), is arranged in at least one gap (53) in such a way, preferably is a fastened to at least one of the two side faces (52) in such a way that, when the width of the gap (53) is reduced, when the two support elements (40, 41) are rotated relative to one another, a pressure is exerted on the part of the torque measuring device (16) arranged in the gap (53), which pressure can be detected as an electrical signal.

19. Torque screwdriver arrangement (1) according to claim 8, wherein the drive housing side support element (40) is formed as an annular fastening flange (22) and/or the screwdriver housing side support element (41) is formed as an annular plate (45), on whose end face (46) facing the drive housing side support element (40) the at least one projection (47) or the at least one recess is arranged and on whose opposite end face (48) there is a sleeve-like extension (49), which is arranged coaxially with a central bore (50) of the annular plate (45), the bore (50) and the extension (49) forming part of a central through-opening (27) of the support arrangement (13), through which, in particular, a part of the output shaft (10) extends and/or into which the output shaft (10) projects.

20. Torque screwdriver arrangement (1) according to claim 19, wherein the sleeve-like extension (49) is provided with an internally or externally threaded section (51) as screwdriver housing connecting means, via which the screwdriver housing side support element (41) is in threaded engagement with a correspondingly formed internally or externally threaded section (32) of the screwdriver housing (4) or of an intermediate element provided between the screwdriver housing side support element (41) and the screwdriver housing (4).

21. Torque screwdriver arrangement (1) according to claim 1, wherein the torque measuring device (16) comprises at least one sensor, such as a resistance sensor and/or an electromagnetic sensor and/or a Hall sensor (16c) and/or a magnetoresistive sensor and/or a galvanomagnetic sensor and/or an optoelectronic sensor and/or a sensor, which is designed and/or set up to detect a torsion angle and/or a position and/or a deformation and/or a twist and/or a torsion and/or a shear force and/or a shear of the in particular torsionally elastic support arrangement (13), in particular of a region of the support arrangement (13), and/or of the drive housing (7).

22. Torque screwdriver arrangement (1) according to claim 1, wherein the torque measuring device (16) comprises at least two measuring device elements, which are designed and/or arranged in such a way that they are displaced relative to one another in the event of a rotational deflection of the in particular torsionally elastic support arrangement (13), and of which at least one is a sensor or a part of a sensor, wherein the measuring device elements are in particular a magnetic field generating element (16b) and a magnetic field measuring element, such as a Hall sensor (16c) and/or a magnetorestive element.

23. Torque screwdriver arrangement (1) according to claim 10, wherein a measuring device element of the torque measuring device (16) is arranged on a radially outer surface (36) of the sleeve (26), in particular mounted on a pedestal (37), and another measuring device element of the torque measuring device (16) is arranged on a radially inner surface (38) of the outer ring, preferably of the annular fastening flange (22), in particular mounted on a pedestal (39), or a vice versa, wherein the two measuring device elements of the torque measuring device (16) are arranged opposite each other but in particular do not touch each other, and the torque measuring device (16) is designed and/or set up to detect a displacement of its two measuring device elements in the circumferential direction of the torsionally elastic support arrangement (13) relative to each other when the sleeve (26) and the outer ring, in particular the fastening flange (22), rotate relative to each other.

24. Torque screwdriver arrangement (1) according to claim 23, wherein an arrangement consisting of the two opposing measuring device elements of the torque measuring device (16) is provided instead of a connecting web (28) and the arrangement is positioned in the circumferential direction of the torsionally elastic support arrangement (13), in particular between two adjacent through-holes (23) of the fastening flange (22).

25. Torque screwdriver arrangement (1) according to claim 1, wherein the drive housing (7) is separated from the screwdriver housing (4) in the radial direction by a gap (6).

26. Torque screwdriver arrangement (1) according to claim 1, wherein the drive train (5) has a gearbox (9), which adjoins the axially front end of the motor (8) and is arranged in the drive housing (7).

27. Torque screwdriver arrangement (1) according to claim 1, wherein a control electronics (3) is provided, which is coupled to the torque measuring device (16) and the motor (8) in order to switch off the motor (8) dependent from output signals of the torque measuring device (16).

28. Torque screwdriver arrangement (1) according to claim 27, wherein the control electronics (3) is an internal control electronics (3b) arranged on the screwdriver housing (4), in particular arranged at least partially within the screwdriver housing (4), an external control electronics (3a) arranged remotely from the screwdriver housing (4) and/or a higher-level controller.

29. Torque screwdriver arrangement (1) according to claim 27, wherein the control electronics (3) comprises a memory (33), in particular a RAM memory, for storing a plurality of predefined target torques and/or a user interface (34) or a setting and/or input means, in particular a touch sensitive screen, a jogwheel and/or a membrane keypad, for setting a target torque in particular stored in the memory (33).

30. Method for operating a torque screwdriver arrangement (1) according to claim 1, wherein
a) when a screw is turned by means of the torque screwdriver arrangement (1), a reaction torque is caused by the output torque of the output shaft (10), which reaction torque is exerted on the drive housing (7) and is supported at exactly one support location (14) on the screwdriver housing (4) via the support arrangement (13), and
b) the torque measuring device (16) detects the output torque of the output shaft (10) in the form of the supported reaction torque at the support arrangement (13).
